(19) United States
(12) Patent Application Publication
(10) Pub. No.: US 2006/0050889 A1
(43) Pub. Date: Mar. 9, 2006

(54) Decrypting block encrypted data

(76) Inventor: Jae Myung Lee, Suwon-si (KR)

Correspondence Address: Robert E. Bushnell, Suite 300, 1522 K Street, N.W., Washington, DC, 20005-1202, US

(21) Appl. No.: 11/221,795

(22) Filed: Sep. 9, 2005

(30) Foreign Application Priority Data
Sep. 9, 2004 (KR) 2004-72352

(51) Int. Cl. H04L 9/00

(52) U.S. Cl. 380/286

(57) ABSTRACT

Decrypting block encrypted data includes: parsing encrypted input data and dividing the parsed data into a ciphertext and a first plaintext defining a decryption policy to be applied to the ciphertext; selecting a decryption policy to preferentially decrypt blocks of the ciphertext from among at least one decryption policy on the basis of the first plaintext divided by the parsing; preferentially decrypting blocks of the ciphertext divided by the parsing according to the selected decryption policy and converting the decrypted blocks into a second plaintext; and selecting a conversion plaintext control policy to be applied to the input data on the basis of the first and second plaintexts, and performing following procedures for undecrypted blocks from the ciphertext according to the plaintext control policy.

### CLAIM OF PRIORITY

This application makes reference to, incorporates the same herein, and claims all benefits accruing under 35 U.S.C. §119 from an application for APPARATUS AND METHOD FOR DECRYPTING BLOCK ENCRYPTED DATA earlier filed in the Korean Intellectual Property Office on Sep. 9, 2004 and there duly assigned Serial No. 2004-72352.

### BACKGROUND OF THE INVENTION

1. Field of the Invention

The present invention relates to decrypting block encrypted data. More specifically, the present invention relates to an apparatus and method to decrypt block encrypted data in which, blocks of entirely encrypted data are preferentially decrypted using the properties of a block encryption mode to be applied (ECB, CBC, XCBC, OFB, CTR mode, and so on) when a length of the data to be decrypted is larger than a block size of an encryption algorithm and a rule to be applied to the entire data is processed using only the decrypted portion of the data so that the data is efficiently processed as compared to when all of the data is decrypted at once.

2. Description of the Related Art

Current widely used block encryption algorithms, such as a Data Encryption Standard (DES), a 3DES and an Advanced Encryption Standard (AES), receive inputted data having a fixed length (block length). Accordingly, data having a length less than a predetermined block length must have padding attached to adapt to the block length, and data having a length greater than the block length must be divided into several pieces to adapt to the block length and each piece is encrypted by the encryption algorithm.

A method of encrypting long input data after dividing the data into several block pieces is classified into an Electronic Code Book (ECB) mode, a Cipher Block Chaining (CBC) mode, an XCBC mode, an Output Feedback (OFB) mode, a Click Through Rate (CTR) mode, and so on, depending on how each block is connected to another.

In particular, while resultant values of encrypted/decrypted blocks are used as a portion of an input value of the next block encryption/decryption in the CBC, XCBC and OFB modes, resultant values of each of input blocks are not used again as an input value to process the encryption/decryption of the next block in the ECB and CTR modes.

In decrypting block encrypted data, when encrypted data is input, the data is parsed into a ciphertext and a plaintext having a selector defining a policy to decrypt the ciphertext; a decryption policy is searched for in response to the selector, the decryption policy having an encryption algorithm to decrypt the corresponding ciphertext, a block connection mode, and coefficients needed to decrypt is output. Then, an entire encrypted portion is decrypted according to the decryption policy and converted into a plaintext. A policy for the plaintext is searched for in a conversion plaintext control policy and the corresponding data is processed.

As such, the data to be encrypted which consists of several blocks is entirely encrypted and then following operations to be applied to the data proceed. For example, blocks constructing a payload encrypted with a CBC mode of a 3DES encryption algorithm used in an Internet Protocol Security (IPSec) protocol or an SSL/TLS protocol are entirely decrypted, and an access control list or a spam filtering policy list is applied to the data generated as a result of the decryption.

The encrypted data which consists of several blocks is entirely decrypted and then the following tasks to be applied to the data proceed. Consequently, tasks that can be applied by encrypting only a portion of the data must be processed after waiting for the entire decryption of the data, which may not be efficient under certain circumstances.

For example, a portion of the data needed to apply the access control list in an IPSec payload does not include all of the blocks that have been decrypted but rather only the beginning several blocks having an IP header or a protocol number and a port number of a layer 4 protocol, and a portion of the data needed to filter spam mail in an SSL payload is only the beginning several blocks in which a title portion of the mail exists when it is previously promised that an advertisement mail is indicated by attaching a headline of ‘[advertisement]’.

In such a case, when a policy is set so that an access control list or a spam mail filter to be applied receives decrypted data, all of the encryption blocks must be decrypted. In this case, a method where only the beginning several blocks are decrypted will not have a remarkable merit.

However, when a policy is set to refuse decrypted data, unnecessary decryption of data to be discarded uses computing resources. That may operate as a main factor to reduce performance, considering that the encryption/decryption is a task consuming considerable computing resources.

### SUMMARY OF THE INVENTION

It is, therefore, an object of the present invention to provide an apparatus and method to decrypt block encrypted data in which a portion of data composed of a set of blocks that are block encrypted is preferentially decrypted, following tasks that can be processed using only the partially decrypted blocks proceed, and then the result is applied to all of the data including blocks that are not yet decrypted, so that it is possible to achieve higher data processing performance.

According to one aspect of the present invention, an apparatus to decrypt block encrypted data is provided, the apparatus comprising: a parser adapted to parse block encrypted input data and to divide the parsed data into a ciphertext and a first plaintext defining a decryption policy to be applied to the ciphertext; a decryption policy selector adapted to select a decryption policy to preferentially decrypt blocks of the ciphertext from among at least one decryption policy on the basis of the first plaintext divided by the parser; a decryptor adapted to preferentially decrypt blocks of the ciphertext divided by the parser according to the decryption policy selected by the decryption policy selector and to convert the decrypted blocks into a second plaintext; and a conversion plaintext processor adapted to select a conversion plaintext control policy to be applied to the input data on the basis of the first and second plaintexts, and to perform following procedures for undecrypted blocks of the ciphertext according to the plaintext control policy.

The decryptor is preferably adapted to receive information on a block connection mode and the number of blocks to be decrypted preferentially according to the selected decryption policy and to sequentially decrypt the blocks of the ciphertext by the received number of blocks to be decrypted preferentially.

The apparatus preferably further comprises a database adapted to store at least one decryption policy selected by the decryption policy selector and a plaintext control policy selected by the conversion plaintext processor.

The database preferably comprises: a first database adapted to store at least one decryption policy to preferentially decrypt blocks of an arbitrary ciphertext; and a second database adapted to store rules to be applied to the second plaintext decrypted and output by the decryptor.

The first database preferably comprises an encryption algorithm adapted to convert input ciphertext data into a plaintext, a block connection mode, a block connection decryption initial vector, a factor value adapted to convert a ciphertext to the plaintext, and at least one entry adapted to define the number of blocks to be decrypted preferentially to become the plaintext.

The encryption algorithm preferably comprises at least one of a Data Encryption Standard (DES), a 3DES, and an Advanced Encryption Standard (AES).

The block connection mode preferably comprises one of a feedback block mode where an association among blocks exists, and a non-feedback block mode where the association among the blocks fails to exist.

The feedback mode preferably comprises at least one of an Output Feedback (OFB) mode, a Cipher Block Chaining (CBC) mode, and an XCBC mode.

The non-feedback mode preferably comprises at least one of ECB and CTR.

The second database is preferably adapted to store at least one factor used to apply at least one of an access control list policy, a data classification policy, a spam mail filtering policy, an e-mail attached file security policy, a web page dynamic script security policy and a quality of service policy using the ciphertext converted into the plaintext.

The input data preferably comprises an Internet Protocol (IP) packet encrypted by an IPSec.

The first plaintext of the input data preferably comprises an IP packet header portion and wherein the ciphertext of the input data comprises a payload of an IP packet.

The first plaintext preferably comprises key information to search for the decryption policy using the plaintext.

The key information preferably comprises at least one of source and destination addresses of an Internet Protocol (IP) header, a layer 4 protocol number, a security policy coefficient of an IPSec header, and an SSL/TLS session ID.

According to another aspect of the present invention, a method of decrypting block encryption data is provided, the method comprising: parsing block encrypted input data and dividing the parsed data into a ciphertext and a first plaintext defining a decryption policy to be applied to the ciphertext; selecting a decryption policy to preferentially decrypt blocks of the ciphertext from among at least one decryption policy on the basis of the first plaintext divided by the parsing; preferentially decrypting blocks of the ciphertext divided by the parsing according to the selected decryption policy and converting the decrypted blocks into a second plaintext; and selecting a conversion plaintext control policy to be applied to the input data on the basis of the first and second plaintexts, and performing following procedures for undecrypted blocks from the ciphertext according to the plaintext control policy.

Selecting the decryption policy preferably comprises searching for a first database that stores the at least one decryption policy in accordance with the first plaintext and selecting a decryption policy with which blocks of the ciphertext are preferentially decrypted.

The first database preferably comprises an encryption algorithm to convert input ciphertext data into a plaintext, a block connection mode, a block connection decryption initial vector, a factor value to convert the ciphertext into the plaintext, and at least one entry defining the number of the blocks to be decrypted preferentially to become the plaintext.

Converting blocks into the second plaintext preferably comprises receiving set information on the block connection mode and the number of blocks to be preferentially decrypted according to the selected decryption policy and sequentially decrypting the ciphertext block by the received number of blocks to be preferentially decrypted.

Performing the following procedures preferably comprises selecting a conversion plaintext control policy to be applied to the input data by searching for the second database storing the plaintext control policy in accordance with the first and second plaintexts and performing the following procedures for the undecrypted blocks from the ciphertext according to the plaintext control policy.

The following procedures preferably comprise omitting an additional decryption procedure for the undecrypted blocks from the ciphertext and defining a following process for data including the first plaintext, the second plaintext, and the undecrypted ciphertext block.

The following procedures preferably comprise discarding the data.

The following procedures preferably comprise commanding at least blocks of the undecrypted blocks from the ciphertext to be additionally decrypted.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a conceptual diagram of decryption of block encrypted data;

FIG. 2 is a block diagram of an apparatus to decrypt block encryption data in accordance with an embodiment of the present invention; and

FIG. 3 is a conceptual diagram of decrypting block encryption data in accordance with an embodiment of the present invention.

### DETAILED DESCRIPTION OF THE INVENTION

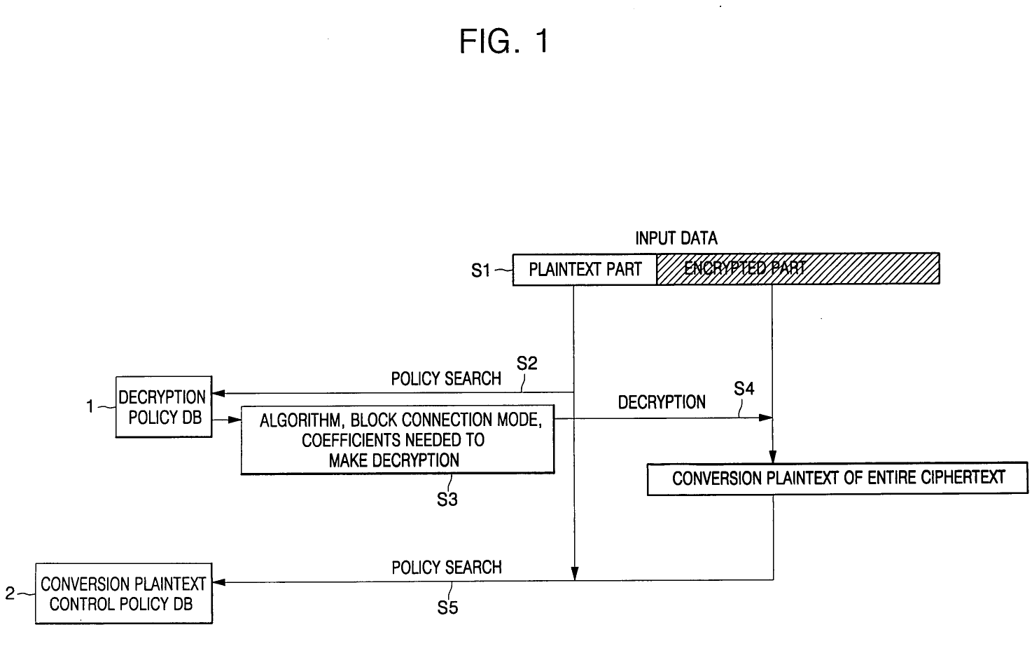

FIG. 1 is a conceptual diagram of decryption of block encrypted data.

Referring to FIG. 1, when encrypted data is input, the data is parsed into a ciphertext and a plaintext having a selector defining a policy to decrypt the ciphertext (S1), a decryption policy DB 1 is searched in accordance with the selector (S2), the decryption policy having an encryption algorithm to decrypt the corresponding ciphertext, a block connection mode, and coefficients needed to decrypt is output (S3). Then, an entirely encrypted portion is decrypted according to the decryption policy and converted into a plaintext (S4). A search is conducted for the policy for the plaintext in a conversion plaintext control policy DB 2 and the corresponding data is processed (S5).

The present invention will now be described more fully hereinafter with reference to the accompanying drawings, in which an exemplary embodiment of the present invention is shown. The present invention can, however, be embodied in different forms and should not be construed as being limited to the embodiment set forth herein. Rather, the embodiment is provided so that this disclosure will be thorough and complete, and will fully convey the scope of the present invention to those skilled in the art. In the drawings, like numbers refer to like elements throughout the specification.

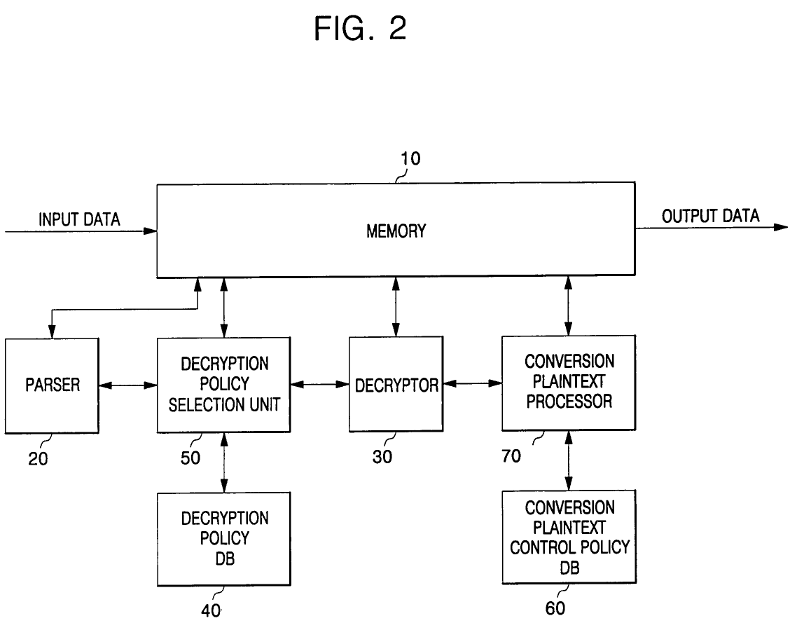

FIG. 2 is a block diagram of an apparatus to decrypt block encrypted data in accordance with an embodiment of the present invention.

Referring to FIG. 2, an apparatus to decrypt a cryptograph in accordance with an embodiment of the present invention includes a memory 10 to store input encrypted data, a parser 20 to divide the data input into the memory 10 into a ciphertext and a selector defining a policy to decrypt the ciphertext, a decryptor 30 to receive the ciphertext and the policy to decrypt to be applied to the ciphertext as input values, converting the input values into plaintexts and outputting them, a decryption policy database 40 to store detailed rules and factor values to apply the decryption policy, a decryption policy selector 50 to search for an entry including the decryption policy to be applied to the corresponding ciphertext in the decryption policy database 40 in accordance with the selector divided by the parser 20 and outputting the searched results to the decryptor 30, a conversion plaintext control policy database 60 to store rules to be applied to the plaintext that has been decrypted and output by the decryptor 30, and a conversion plaintext processor 70 to perform following procedures for blocks that are not yet decrypted with reference to the policy stored in the conversion plaintext control policy database 60 with respect to the data output from the decryptor 30.

When arbitrary encrypted data is input into the decryption processing apparatus, the memory 10 temporarily stores the corresponding data. While the encrypted data is stored in the memory 10, the parser 20 and the decryptor 30 access the corresponding data and perform the parsing and decryption for the corresponding data.

The parser 20 accesses the encrypted data stored in the memory 10 and divide the input data such as an IPSec or SSL/TLS packet into two portions consisting of a pure ciphertext portion and a policy selector in plaintext used to find a policy and factor values to decrypt the ciphertext.

An explanation of the Internet protocol security protocol (IPSec) and secure socket layer/transport layer security (SSL/TLS) follows.

Since it is not yet possible to communicate when security protocols such as a data packet and a key management system of a virtual private network gateway are not matched between developers when constructing a virtual private network, a standardization task associated with the virtual private network is in progress centering around an IETF IPSec working group to solve the above problem.

Contents related to a network security such as a security protocol, an encryption technology, and a key management technology are under development according to the recommendation progressed to be standardized in the IPSec working group, and the standardization is in progress centering around an Authentication Header (AH), an Encapsulating Security Payload (ESP), and a key management mechanism.

The IPSec is a structure to provide stability for transmission and reception of an IP packet among IP layers, which provides a security service for all of the data from a high layer in a host between terminals. That is, it provides a security service of authentication, integrity, and confidentiality for the IP packet.

In order to provide such a security service, an Internet Key Management Protocol (IKMP), a Security Association (SA), an encryption algorithm, and so on are defined.

The IPSec is one of the fields that are actively studied in the IETF, and two new working groups related to the IPSec were established recently. One of them is an IP Security Policy working group, which is performing a study to develop an extendable specification language, a policy exchange protocol and a negotiation protocol in order to provide a guide for an IPSec policy provision.

The other is an IP Security Access working group, which is performing a study to define a mechanism to transfer user's configuration information and user's access control information from a user's private network to a network where the IPSec is implemented.

The Secure Socket Layer (SSL) was suggested for the first time by Netscape, a web browser developer, and embodied for the first time in the web application of the company. The SSL is a security protocol that is now well known as a representative of WWW security, which has been developed up to version 3.0 and is widely being used in most of browsers such as Netscape and Internet Explore. The Transport Layer Security (TLS) is a web security mechanism that is standardized by IETF, which provides the same function as the SSL and was designed based on the SSL 3.0.

The SSL/TLS forms a secure channel between two application programs that communicate in an Internet environment and keeps security of communication contents. That is, communication security is constructed by forming an encrypted channel between a server and a client when performing WWW communication.

The SSL/TLS is not dependent upon a specific application program since it is performed between an application program and a TCP, can support all application programs that use the TCP/IP, and provides a security service between two applications, a client and server authentication service and a message integrity service.

In the case of the IPSec, since the plaintext portion that can be interpreted by the parser 20 is only an IP protocol header portion and the remaining portion except the IP header (IP payload portion) is encrypted, the parser 20 cannot be used as a policy selector.

Source and destination IP addresses and Security Policy Indicator (SPI) information from the IP header can be most usefully used as a policy selector.

In the case of the SSL/TLS, an SSL/TLS session ID is a plaintext that is not encrypted, which can be usefully used as policy selector information.

The decryptor 30 has a capability to divide encryption algorithms such as DES, 3DES and AES in a block unit and process them, and a block length to be able to receive and a mode to connect the blocks in each of the encryption algorithms are previously determined.

The decryption policy database 40 is composed of an entry set in which the encryption algorithm used to convert input ciphertext data into a plaintext, factor values needed to convert the block connection mode and other ciphertexts into a plaintext, the number of blocks to be decrypted and then to preferentially become plaintext, and so on.

The conversion plaintext control policy database 60 comprises entries including an Access Control List (ACL) policy to be applied to the converted plaintext, a data classification policy, a quality of service policy, and so on.

The following is a description of the operation of the apparatus for decrypting encrypted data in accordance with the present invention configured as described above.

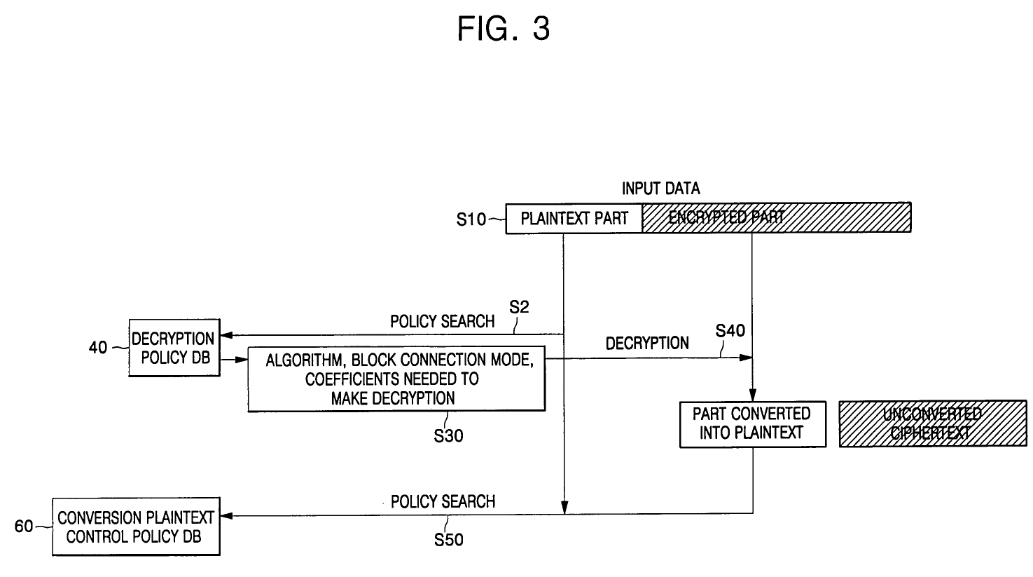

FIG. 3 is a view explaining a decryption procedure of encrypted data in accordance with an embodiment of the present invention.

Referring to FIG. 3, when encrypted data is input into a decryption processing apparatus, the data is stored in the memory 10. The input data stored in the memory 10 is divided into a decryption policy selector of a header portion plaintext and a ciphertext of a payload portion using the parser 20 (S10).

The decryption policy processor 50 searches for a decryption policy entry to decrypt the ciphertext in the decryption policy database 40 using the decryption policy selector of the plaintext divided by the parser 20 (S20).

The decryption policy selector searches for the decryption policy DB entry including address information of a plaintext portion of a message. Examples of the address information include source and destination IP addresses, a security policy index (SPI) of an IPSec option header, or an SSL/TLS session ID.

When a proper entry exists as a result of searching for the corresponding decryption entry in the decryption policy database 40 using the decryption policy selector, the decryption policy processor 50 extracts indices needed to process the decryption task from the entry (S30).

The task corresponds to finding one security association using the IP address and SPI as the decryption policy selector in the case of the IPSec, and to finding the SSL/TLS session entry using the IP address and SSL/TLS session ID as the decryption policy selector in the case of the SSL/TLS.

The indices that are extracted in the entry for the decryption task include an encryption algorithm, a connection mode between blocks, a block connection decryption initial vector, and the number of blocks to be decrypted preferentially.

For example, the 3 DES or AES block algorithm used in the IPSec or SSL/TLS, connection mode information between blocks such as a CBC mode, an XCBC mode, CTR mode, and so on, and a preferential decryption block index set as a block length (40 bytes) including a length of an internal IP header in the case of the IPSec tunnel or a block length including up to a header portion of an e-mail in the case of the SSL/TLS are set as the coefficient.

The decryptor 30 performs decryption for data stored in the memory 10 by reflecting an index to decrypt, which is extracted from the decryption policy database 40 by the decryption policy processor 50 (S40).

Since the index extracted by the decryption policy processor 50 has the number of the blocks to be preferentially decrypted, when an encryption is performed in the CBC, XCBC, and OFB modes where a resultant value of block process that was just previously encrypted/decrypted is used as an input value of the block to be processed next, the decryptor 30 decrypts only the number of blocks to be preferentially decrypted from the beginning of the ciphertext.

On the other hand, although any portion of the block of the encrypted data can be decrypted by selecting a predetermined number of blocks in the case of the ECB or CTR mode where the resultant value of block processing is not used as an input value of another block process, since information on a data packet generally exists in the front portion of the packet, a predetermined number of the blocks from the beginning of the ciphertext are preferentially decrypted and the result is stored in the memory 10.

The plaintext processor 70 searches for a control policy in the conversion plaintext control policy database 60 using a plaintext of an original header portion divided by the parser 20 and a plaintext of the block that is preferentially decrypted (S50).

A key used to search for an entry of the conversion plaintext control policy database can be plaintext portion address information of the message, complex sentence portion address information of the message, or a complex sentence data value of the message.

In particular, a header of an application layer protocol or the like can be positioned in the complex sentence portion data value of the message, and the complex sentence portion data value of the message comprises a data value, that can be relatively more important, such as a mail title of an e-mail protocol.

The conversion plaintext control policy database 60 is composed of a set of entries which define an access control list policy (ACL policy) to be applied to the converted plaintext, a data classification policy, a spam filtering policy, a quality of service policy, and so on.

Accordingly, the conversion plaintext control policy database 60 can store a determination as to whether to permit or refuse depending on a security policy, a determination as to whether or not to assign resources and to apply a priority depending on a message quality of security policy, a determination as to whether or not to further apply an additional and partial decryption, and the number of additional decryption blocks.

When a proper policy is found as a result of searching for a corresponding entry in the conversion plaintext control policy database 60 by the plaintext processor 70, if the operation defined by the policy is needed to decrypt all of the ciphertext, the remaining portion of the ciphertext that is not yet decrypted is also decrypted. However, if it is possible to apply the control policy, the control policy is applied without decrypting the remaining portion of the ciphertext.

For example, if an ACL to be applied to the decrypted IPSec packet should refuse a corresponding packet, the corresponding packet is discarded without having to decrypt the remaining portion of the ciphertext that is not yet decrypted.

For another example, a spam mail filter to be applied to the SSL/TLS packet is set to discard an advertisement mail, only a portion of ‘[advertisement]’ of a mail title is decoded and the remaining portion is discarded without having to perform decryption.

For another example, when a mail server is set to filter web pages such as an ActiveX or JAVA applet, which have a script that is usually used in hacking due to a security drawback using a web page dynamic script security policy applied to the SSL/TLS packet, the corresponding packet is discarded without having to decrypt an attached file.

According to the present invention, when a portion of data composed of several encrypted blocks is preferentially decrypted and then a rule to be applied to all of the data is processed using the decryption result, a decryption task for the remaining portion of the corresponding data is omitted and following tasks proceed, and the result is applied to all of the data including blocks that are not yet decrypted so that it is possible to effect a higher performance of data processing.

Accordingly, it is possible to provide an effect that encryption/decryption operation consuming excessive computing resources is reduced to the minimum and then performance of a system requiring the encryption/decryption can be enhanced to the maximum.

Although exemplary embodiments of the present invention have been described, it will be understood by those skilled in the art that the present invention is not limited to the described embodiments. Rather, various changes and modifications can be made within the spirit and scope of the present invention, as defined by the following claims.

What is claimed is:

1. An apparatus to decrypt block encrypted data, the apparatus comprising:
a parser adapted to parse block encrypted input data and to divide the parsed data into a ciphertext and a first plaintext defining a decryption policy to be applied to the ciphertext;
a decryption policy selector adapted to select a decryption policy to preferentially decrypt blocks of the ciphertext from among at least one decryption policy on the basis of the first plaintext divided by the parser;
a decryptor adapted to preferentially decrypt blocks of the ciphertext divided by the parser according to the decryption policy selected by the decryption policy selector and to convert the decrypted blocks into a second plaintext; and
a conversion plaintext processor adapted to select a conversion plaintext control policy to be applied to the input data on the basis of the first and second plaintexts, and to perform following procedures for undecrypted blocks of the ciphertext according to the plaintext control policy.

2. The apparatus according to claim 1, wherein the decryptor is adapted to receive information on a block connection mode and the number of blocks to be decrypted preferentially according to the selected decryption policy and to sequentially decrypt the blocks of the ciphertext by the received number of blocks to be decrypted preferentially.

3. The apparatus according to claim 1, further comprising a database adapted to store at least one decryption policy selected by the decryption policy selector and a plaintext control policy selected by the conversion plaintext processor.

4. The apparatus according to claim 3, wherein the database comprises:
a first database adapted to store at least one decryption policy to preferentially decrypt blocks of an arbitrary ciphertext; and
a second database adapted to store rules to be applied to the second plaintext decrypted and output by the decryptor.

5. The apparatus according to claim 4, wherein the first database comprises an encryption algorithm adapted to convert input ciphertext data into a plaintext, a block connection mode, a block connection decryption initial vector, a factor value adapted to convert a ciphertext to the plaintext, and at least one entry adapted to define the number of blocks to be decrypted preferentially to become the plaintext.

6. The apparatus according to claim 5, wherein the encryption algorithm comprises at least one of a Data Encryption Standard (DES), a 3DES, and an Advanced Encryption Standard (AES).

7. The apparatus according to claim 5, wherein the block connection mode comprises one of a feedback block mode where an association among blocks exists, and a non-feedback block mode where the association among the blocks fails to exist.

8. The apparatus according to claim 7, wherein the feedback mode comprises at least one of an Output Feedback (OFB) mode, a Cipher Block Chaining (CBC) mode, and an XCBC mode.

9. The apparatus according to claim 7, wherein the non-feedback mode comprises at least one of ECB and CTR.

10. The apparatus according to claim 4, wherein the second database is adapted to store at least one factor used to apply at least one of an access control list policy, a data classification policy, a spam mail filtering policy, an e-mail attached file security policy, a web page dynamic script security policy and a quality of service policy using the ciphertext converted into the plaintext.

11. The apparatus according to claim 1, wherein the input data comprises an Internet Protocol (IP) packet encrypted by an IPSec.

12. The apparatus according to claim 1, wherein the first plaintext of the input data comprises an IP packet header portion and wherein the ciphertext of the input data comprises a payload of an IP packet.

13. The apparatus according to claim 1, wherein the first plaintext comprises key information to search for the decryption policy using the plaintext.

14. The apparatus according to claim 13, wherein the key information comprises at least one of source and destination addresses of an Internet Protocol (IP) header, a layer 4 protocol number, a security policy coefficient of an IPSec header, and an SSL/TLS session ID.

15. A method of decrypting block encryption data, the method comprising:
parsing block encrypted input data and dividing the parsed data into a ciphertext and a first plaintext defining a decryption policy to be applied to the ciphertext;
selecting a decryption policy to preferentially decrypt blocks of the ciphertext from among at least one decryption policy on the basis of the first plaintext divided by the parsing;
preferentially decrypting blocks of the ciphertext divided by the parsing according to the selected decryption policy and converting the decrypted blocks into a second plaintext; and
selecting a conversion plaintext control policy to be applied to the input data on the basis of the first and second plaintexts, and performing following procedures for undecrypted blocks from the ciphertext according to the plaintext control policy.

16. The method according to claim 15, wherein selecting the decryption policy comprises searching for a first database that stores the at least one decryption policy in accordance with the first plaintext and selecting a decryption policy with which blocks of the ciphertext are preferentially decrypted.

17. The method according to claim 16, wherein the first database comprises an encryption algorithm to convert input ciphertext data into a plaintext, a block connection mode, a block connection decryption initial vector, a factor value to convert the ciphertext into the plaintext, and at least one entry defining the number of the blocks to be decrypted preferentially to become the plaintext.

18. The method according to claim 15, wherein converting blocks into the second plaintext comprises receiving set information on the block connection mode and the number of blocks to be preferentially decrypted according to the selected decryption policy and sequentially decrypting the ciphertext block by the received number of blocks to be preferentially decrypted.

19. The method according to claim 15, wherein performing the following procedures comprises selecting a conversion plaintext control policy to be applied to the input data by searching for the second database storing the plaintext control policy in accordance with the first and second plaintexts and performing the following procedures for the undecrypted blocks from the ciphertext according to the plaintext control policy.

20. The method according to claim 19, wherein the following procedures comprise omitting an additional decryption procedure for the undecrypted blocks from the ciphertext and defining a following process for data including the first plaintext, the second plaintext, and the undecrypted ciphertext block.

21. The method according to claim 20, wherein the following procedures comprise discarding the data.

22. The method according to claim 15, wherein the following procedures comprise commanding at least blocks of the undecrypted blocks from the ciphertext to be additionally decrypted.
